(19) United States
(12) Patent Application Publication
(10) Pub. No.: US 2014/0118228 A1
(43) Pub. Date: May 1, 2014

(54) ORGANIC LIGHT EMITTING DISPLAY DEVICE AND METHOD OF GENERATING GRAY SCALE VOLTAGE IN THE ORGANIC LIGHT EMITTING DISPLAY DEVICE

(71) Applicant: SAMSUNG DISPLAY CO., LTD., Yongin-City (KR)

(72) Inventor: Sung-Jin KANG, Yongin-City (KR)

(21) Appl. No.: 13/785,119

(22) Filed: Mar. 5, 2013

(30) Foreign Application Priority Data
Oct. 31, 2012 (KR) 10-2012-0121963

(51) Int. Cl. G09G 3/32

(52) U.S. Cl. CPC G09G 3/3258
USPC 345/77

(57) ABSTRACT

A method of generating a gray scale voltage in an organic light emitting display device includes setting a gamma table, based on the emission of light with a first luminance level by a screen displayed in a pixel unit of the light emitting display device, and implementing a gamma reference voltage lookup table (LUT) in which voltage values of red, green and blue data corresponding to each gray scale and luminances at the first luminance level are recorded based on the gamma table; selecting a second luminance level different from the first luminance level; fixing a specific gray scale corresponding to a low gray scale region as a reference gray scale, actually measuring, at the second luminance level, a voltage corresponding to the fixed reference level; and generating gray scale voltages corresponding to the second luminance level through a plurality of set gamma reference voltages.

### CLAIM OF PRIORITY

This application makes reference to, incorporates the same herein, and claims all benefits accruing under 35 U.S.C. §119 from an application for ORGANIC LIGHT EMITTING DISPLAY DEVICE AND METHOD OF GENERATING GRAY SCALE VOLTAGE IN THE ORGANIC LIGHT EMITTING DISPLAY DEVICE earlier filed in the Korean Intellectual Property Office on 31 Oct. 2012 and there duly assigned Serial No. 10-2012-0121963.

### BACKGROUND OF THE INVENTION

1. Field of the Invention

An aspect of the present invention relates to an organic light emitting display device, and more particularly, to a method of generating a gray scale voltage in an organic light emitting display device, which method can implement a continuous dimming mode.

2. Description of the Related Art

An organic light emitting display device is a kind of flat panel display device which uses an organic compound as a light emitting material. The organic light emitting display device has excellent luminance and color purity and is thin and light. In addition, the organic light emitting display device can be driven with low power. Thus, it is expected that the organic light emitting display device will be widely used in various display devices including portable display devices.

However, existing organic light emitting display devices have a disadvantage in that it is difficult to implement a dimming mode in which the luminance (brightness) of a display image is adjusted.

Conventionally, there has been proposed a method of previously setting a certain number of dimming modes (luminance levels) and collectively applying a fixed gamma table to gamma implementation for each dimming mode in order to implement a dimming mode of an organic light emitting display device. In the method, the gamma table at the maximum luminance level is identically applied to each dimming mode including a low luminance level.

However, in this case, the luminance and color of an image displayed for each dimming mode may become non-uniform, and the luminance of the image cannot be adjusted in the other dimming modes except some predetermined dimming modes.

### SUMMARY OF THE INVENTION

Embodiments provide an organic light emitting display device and a method of generating a gray scale voltage in the organic light emitting display device. The method can naturally implement a continuous dimming mode by obtaining a gamma reference voltage suitable for an arbitrarily selected luminance. The continuous dimming mode is obtained without dividing a luminance level into several fixed luminance levels, and accordingly, an optimal gray scale voltage for the arbitrarily selected luminance may be generated.

Embodiments also provide an organic light emitting display device and a method of generating a gray scale voltage in the organic light emitting display device, in which a specific gray scale in a low gray scale region is fixed as a reference gray scale, a voltage of the fixed reference gray scale is actually measured, and the actually measured voltage is output as a gamma reference voltage corresponding to the low gray scale region, thereby preventing color distortion in the low gray scale region when a dimming mode is implemented.

According to an embodiment of the present invention, there is provided a method of generating a gray scale voltage in an organic light emitting display device, the method including: setting a gamma table, based on the emission of light with a first luminence level by a screen displayed in a pixel unit of the light emitting display device, and implementing a gamma reference voltage lookup table (LUT) in which voltage values of red, green and blue data corresponding to each gray scale, and luminances at the first luminance level are recorded based on the gamma table; selecting a second luminance level different from the first luminance level; outputting a gamma reference voltage control signal corresponding to the second luminance level with reference to the gamma table and the gamma reference voltage LUT; receiving the gamma reference voltage control signal so as to set first gamma reference voltages corresponding to the second luminance level; fixing a specific gray scale corresponding to a low gray scale region as a reference gray scale, actually measuring, at the second luminance level, a voltage corresponding to the fixed reference level, and setting the actually measured voltage as a second gamma reference voltage; and generating gray scale voltages corresponding to the second luminance level through the plurality of set gamma reference voltages and outputting the generated gray scale voltages to a data driver.

The first gamma reference voltages may be gamma reference voltages but may not be the second gamma reference voltage corresponding to the low gray scale region.

The second gamma reference voltage corresponding to the low gray scale region may be set to a voltage corresponding to the reference gray scale, which is always fixed regardless of the gamma reference voltage control signal and the selected second luminance level.

The reference gray scale may be gray scale 15.

The first luminance level is a maximum luminance level.

The gray scale voltages may be generated by dividing voltages between the plurality of gamma reference voltages.

The gamma reference voltage control signal may be a signal for controlling voltage values of the data obtained corresponding to the second luminance level through the gamma reference voltage LUT to be set to the first gamma reference voltages generated in a gamma correction circuit.

The gamma table may be set by applying a reference offset value for performing gamma voltage correction for a predetermined reference gray scale, based on emission of light with the first luminence level from the screen, and an additional offset value for performing gamma voltage correction for at least one of the other gray scales not identical with the reference gray scale.

The gamma table may be set by applying a reference color coordinate offset value for a predetermined reference gray scale, based on emission of light with the first luminence level from the screen, and an additional color coordinate offset value for at least one of the other gray scales not identical with the reference gray scale.

According to an embodiment of the present invention, there is provided an organic light emitting display device, including: a pixel unit having pixels coupled to a plurality of scan lines and a plurality of data lines; a luminance/color coordinate correction unit that includes a gamma table set based on emission of light with a first luminence level from a screen displayed in a pixel unit of the light emitting display device, and a gamma reference voltage LUT in which voltage values of red, green and blue data corresponding to each gray scale and luminance at the first luminance level are recorded based on the gamma table; a gamma control signal output unit that outputs a gamma reference voltage control signal corresponding to the second luminance level with reference to the gamma table and the gamma reference voltage LUT; and a gamma correction circuit that receives the gamma reference voltage control signal so as to generate a plurality of gamma reference voltages corresponding to the second luminance level, a gamma reference voltage corresponding to a low gray scale region among the gamma reference voltages generated in the gamma correction circuit being generated by fixing a specific gray scale corresponding to the low gray scale region as a reference gray scale.

The gamma reference voltage corresponding to the low gray scale region may be set to a voltage corresponding to the reference gray scale, which is always fixed regardless of the gamma reference voltage control signal and the selected second luminance level. The reference gray scale may be gray scale 15.

The first luminance level may be a maximum luminance level. The maximum luminance level may be 300 cd/m².

The gamma correction circuit may generate the gray scale voltages by dividing voltages between the plurality of gamma reference voltages.

As described above, according to the present invention, a continuous dimming mode can be implemented by obtaining a gamma reference voltage suitable for an arbitrarily selected luminance; the continuous dimming mode is obtained without dividing a luminance level into several fixed luminance levels, and accordingly, generating an optimal gray scale voltage for the arbitrarily selected luminance.

Further, a specific gray scale in a low gray scale region is fixed as a reference gray scale, a voltage of the fixed reference gray scale is actually measured, and the actually measured voltage is output as a gamma reference voltage corresponding to the low gray scale region, thereby preventing color distortion in the low gray scale region when a dimming mode is implemented.

### BRIEF DESCRIPTION OF THE DRAWINGS

These and/or other aspects will become apparent and more readily appreciated from the following description of the embodiments, taken in conjunction with the accompanying drawings of which:

FIG. 1 is a view illustrating a structure of an organic light emitting display device according to an embodiment of the present invention.

FIG. 2 is a circuit diagram illustrating a structure of an embodiment of a pixel shown in FIG. 1.

FIG. 3 is a view illustrating a structure of a data driver according to an embodiment of the present invention.

FIG. 4 is a block diagram illustrating a structure of a gray level generator according to an embodiment of the present invention.

FIG. 5A is a graph illustrating a gamma table according to an embodiment of the present invention, FIG. 5B is a view illustrating a gamma reference voltage lookup table (LUT) implemented based on FIG. 5A, and FIG. 5C is a view illustrating examples of red, green and blue data voltages when a specific dimming mode is selected.

FIG. 6 is a view illustrating examples of a reference gray scale in a low gray scale region and voltage values of red, green and blue data corresponding to the reference gray scale when a specific dimming mode is selected according to another embodiment of the present invention.

FIG. 7 is a flowchart illustrating a method of generating a gray scale voltage according to an embodiment of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

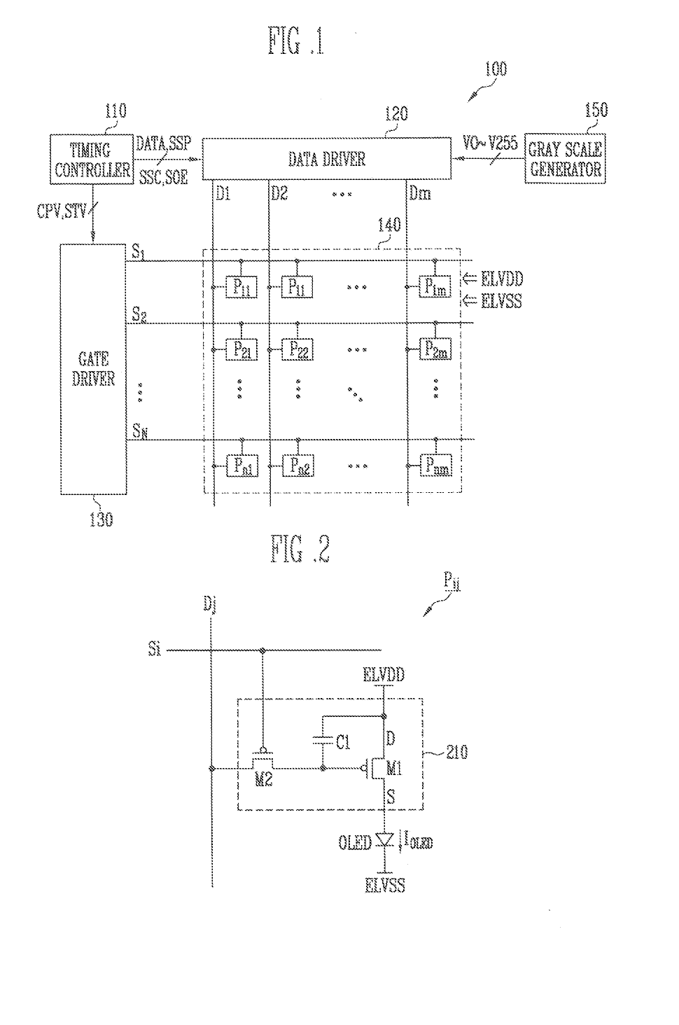

FIG. 1 is a view illustrating a structure of an organic light emitting display device according to an embodiment of the present invention.

Referring to FIG. 1, the organic light emitting display device 100 according to this embodiment includes a timing controller 110 that generates control signals and outputs the generated control signals to a data driver 120 and a gate driver 130, the data driver 120 that outputs a data voltage corresponding to an input image to a plurality of pixels P11 to Pnm through data lines D1 to Dm, the gate driver 130 that outputs scan signals to the respective pixels P11 to Pnm through scan lines S1 to Sn, a pixel unit 140 having the pixels P11 to Pnm coupled to the scan lines S1 to Sn and the data lines D1 to Dm, and a gray scale generator 150 that generates a plurality of gray scale voltages V0 to V255 and supplies the generated gray scale voltages to the data driver 120.

The gate driver 130 may perform an operation of outputting an emission control signal to a plurality of emission control lines (not shown) coupled to the plurality of pixels, as well as the scan lines.

The timing controller 110 receives an input image signal and an input control signal for controlling the display of the input image signal from an external graphic controller (not shown). The timing controller 110 generates an input image data DATA, a source start pulse SSP, a source shift clock SSC, a source output enable (SOE), etc. from the input image signal and the input control signal, and outputs them to the data driver 120. The timing controller 110 generates a gate driving clock CPV, a start pulse STV, etc., and outputs them the gate driver 130.

The pixel unit 140 has the plurality of pixels P11 to Pnm positioned at intersection portions of the scan lines S1 to Sn and the data lines D1 to Dm. The pixels P11 to Pnm may be arranged in an m*n matrix form as shown in FIG. 1. Each of the pixels P11 to Pnm includes a light emitting element, and receives high and low power voltages ELVDD and ELVSS for actuating the light emitting element (organic light emitting diode) from the outside. Each of the pixels P11 to Pnm allows the light emitting element to emit light with luminance corresponding to the data voltage by supplying driving current or voltage to the light emitting element.

Each of the pixels P11 to Pnm controls the amount of current supplied to the light emitting element, corresponding to a data voltage supplied through the data lines D1 to Dm, and the light emitting element emits light with luminance corresponding to the data voltage.

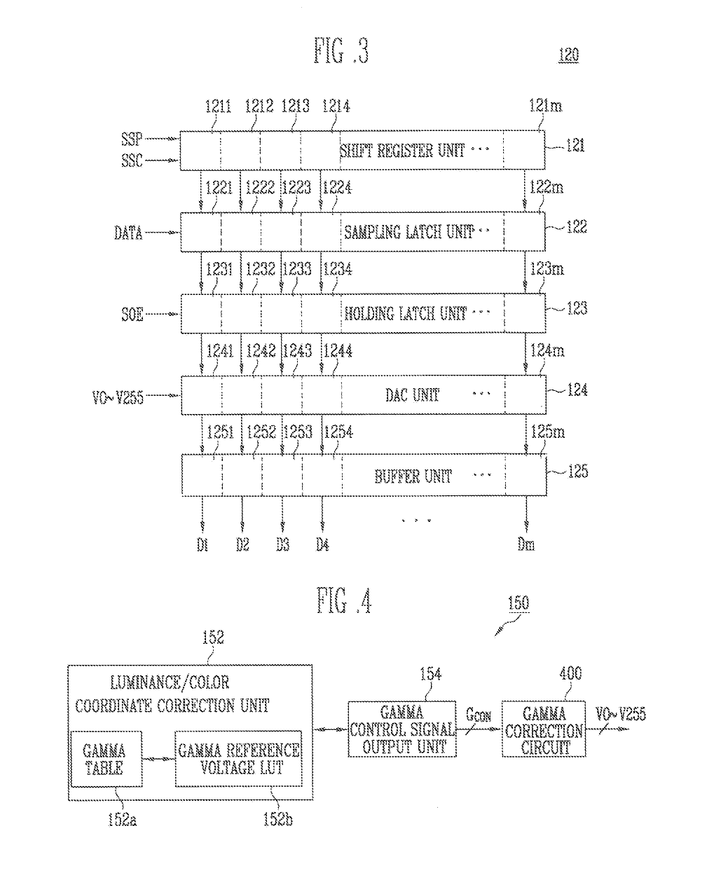

FIG. 2 is a circuit diagram illustrating a structure of an embodiment of a pixel Pij shown in FIG. 1.

The pixel provided in the organic light emitting display device according to the present invention is not limited to the embodiment of FIG. 2.

The pixel Pij according to this embodiment includes an organic light emitting diode OLED as a light emitting element and a pixel circuit 210. The organic light emitting diode OLED emits light by receiving driving current I_{OLED} output from the pixel circuit 210. The luminance of the light emitted from the organic light emitting diode OLED is changed depending on the amplitude of the driving current I_{OLED}.

The pixel circuit 210 may include a capacitor C1, a driving transistor M1 and a switching transistor M2. The driving transistor M1 includes a first terminal D through which a high power voltage ELVDD is supplied to the driving transistor M1, a second terminal S coupled to an anode of the organic light emitting diode OLED, and a gate terminal coupled to a second terminal of the switching transistor M2. The anode of the organic light emitting diode OLED is coupled to the second terminal S of the driving transistor M1, and a cathode of the organic light emitting diode OLED is coupled to a low power voltage ELVSS.

The switching transistor M2 includes a first terminal coupled to a data line Dj, the second terminal coupled to the gate terminal of the driving transistor M1, and a gate terminal coupled to a scan line Si. The capacitor C1 is coupled between the gate terminal and first terminal D of the driving transistor M1.

If a scan signal having a gate-on level is supplied to the switching transistor M2 through the scan line Si, a data voltage is applied to the gate terminal of the driving transistor M1 and a first terminal of the capacitor C1 through the switching transistor M2. While a valid data voltage is applied through the data line Dj, a voltage level corresponding to the data voltage is charged in the capacitor C1. The driving transistor M generates driving current I_{OLED} according to the voltage level of the data voltage and outputs the generated driving current to the organic light emitting diode OLED.

The organic light emitting diode OLED receives the driving current I_{OLED} input from the pixel circuit 210, so as to emit light with luminance corresponding to the data voltage.

The data driver 120 generates a data voltage using the input image data DATA, the source start pulse SSP, the source shift clock SSC and the source output enable SOE, which are input from the timing controller 110, and outputs the generated data voltage to the plurality of pixels P11 to Pnm through the data lines D1 to Dm. The data voltage may be output to a plurality of pixels positioned on the same row during one horizontal period. Each of the plurality of data lines D1 to Dm through which the data voltage is applied to pixels P11 to Pnm may be coupled to a plurality of pixels positioned on the same column.

FIG. 3 is a view illustrating a structure of the data driver 120 according to an embodiment of the present invention.

Referring to FIG. 3, the data driver 120 includes a shift register unit 121, a sampling latch unit 122, a holding latch unit 123, a digital-analog converter (DAC) unit 124 and a buffer unit 125.

The shift register unit 121 receives a source start pulse SSP and a source shift clock SSC, supplied from the timing controller 110. The shift register unit 121 that has received the source shift clock SSC and the source start clock SSP progressively generates m sampling signals while shifting the source start pulse SSP every one period of the source shift clock SSC.

To this end, the shift register unit 121 has m shift registers 1211 to 121m.

The sampling latch unit 122 progressively stores the input image data DATA in response to sampling signals progressively supplied from the shift register unit 121. To this end, the sampling latch unit 122 has m sampling latches 1221 to 122m for storing m input image data DATA.

The holding latch unit 123 receives a source output enable SOE supplied from the timing controller 110. The holding latch unit 123 that has received the source output enable SOE receives input image data DATA input from the sampling latch unit 122 and stores the input image data DATA. The holding latch unit 123 supplies, to the DAC unit 124, the input image data DATA stored therein. To this end, the holding latch unit 123 has m holding latches 1231 to 123m.

The DAC unit 124 receives input image data DATA input from the holding latch unit 123 and receives gray scale voltages V0 to V255 input from the gray scale generator 150, so as to generate m data voltages, corresponding to the input image data DATA. To this end, the DAC unit 124 has m DACs 1241 to 124m. That is, the DAC unit 124 generates m data voltages using DACs 1241 to 124m respectively positioned in channels, and supplies the generated data voltages to the buffer unit 125.

The buffer unit 125 supplies the m data voltages supplied from the DAC unit 124 respectively to m data lines D1 to Dm. To this end, the buffer unit 125 has m buffers 1251 to 125m.

The gate driver 130 generates a scan signal, using the gate driving pulse CPV, the start pulse STV, etc., input from the timing controller 110, and outputs the generated scan signal to each of the pixels P11 to Pnm through the scan lines S1 to Sn.

As described above, the gate driver 130 may output an emission control signal to each of the pixels P11 to Pnm through the emission control lines (not shown). That is, the scan lines S1 to Sn and the emission control lines (not shown) may progressively or simultaneously output, for each row, scan signals and emission control signals, respectively. According to an embodiment, in the organic light emitting display device 100, the gate driver 130 may generate an additional driving signal and output the generated driving signal to each of the pixels P11 to Pnm.

The gray scale voltage generator 150 generates a plurality of gamma-corrected gray scale voltages V0 to V255, and outputs the generated gray scale voltages to the data driver 120. The number of the plurality of gray scale voltages V0 to V255 may be changed depending on the number of gray scales expressed in the organic light emitting display device 100. Although it has been described in this embodiment that the gray scales expressed in the organic light emitting display device 100 are 256 gray scales, the present invention is not necessarily limited thereto.

According to this embodiment, when dimming is performed in the organic light emitting display device 100, predetermined dimming modes are not provided, but a gamma reference voltage is computed to be suitable for an arbitrarily selected luminance, i.e., an arbitrary dimming mode, and accordingly, optimal gray scale voltages for the arbitrarily selected luminance are generated, so that it is possible to naturally implement a continuous dimming mode.

More specifically, in this embodiment, a gamma table and data voltages corresponding to gray scales 0 to 255 in the gamma table are determined, based on when the organic light emitting display device emits light with the maximum luminance level. Subsequently, if a user selects an arbitrary luminance level (dimming mode), a data voltage corresponding to the selected luminance level is set to the gamma reference voltage, based on the gamma table at the determined maximum luminance level, so that the dimming mode of the organic light emitting display device is implemented.

FIG. 4 is a block diagram illustrating a structure of the gray level generator according to an embodiment of the present invention.

Referring to FIG. 4, the gray scale voltage generator 150 according to this embodiment includes a luminance/color coordinate correction unit 152, a gamma control signal output unit 154 and a gamma correction circuit 400.

A gamma table 152a and a gamma reference voltage lookup table (LUT) 152b are included in the luminance/color coordinate correction unit 152. Here, the gamma table 152a is set based on the condition allowing the organic light emitting display device 100 to emit light with the maximum luminance level. In the gamma reference voltage LUT 152b, voltage values of red, green and blue data corresponding to each gray scale and luminance at the maximum luminance level are recorded, based on the gamma table 152a.

In case of existing organic light emitting display devices, the luminance of each manufactured product may be different from a target luminance due to the variation between manufacturing processes, regardless of implementation of a dimming mode.

Therefore, it is required to correct the luminance measured in each organic light emitting display device to be identical to the target luminance. In a case where only the luminance of the organic light emitting display device is corrected, white balance may be distorted due to the difference in efficiency among red, green and blue pixels, and therefore, correction is performed on color coordinates, as well as luminance.

Accordingly, in this embodiment, the luminance/color coordinate correction unit 152 sets a reference offset value for performing gamma voltage correction for a predetermined reference gray scale (e.g., gray scale 255, gray scale 171, gray scale 87, gray scale 59, etc.), based on the input conditions of the OLED when the organic light emitting display device 100 emits light with the maximum luminance level, and sets an additional offset value(s) for at least one of the other gray scales except the reference gray scale. Thus, the luminance/color coordinate correction unit 152 sets an optimal gamma table at the maximum luminance level by applying the additional offset value to the gamma voltage correction corresponding to the gray scale.

Further, voltage values respectively corresponding to gray scales 0 to 255 at the maximum luminance level are determined through the set optimal gamma table 152a. That is, the luminance/color coordinate correction unit 152 includes the gamma reference voltage LUT 152b in which voltage values of red, green and blue data corresponding to each gray scale and luminance at the maximum luminance level are recorded.

More specifically, an operation of the luminance/color coordinate correction unit 152 will be described as follows.

First, the luminance/color coordinate correction unit 152 measures luminance and color coordinate for a reference gray scale by analyzing a screen on which the pixel unit (140 of FIG. 1) of the organic light emitting display device 100 emits light with luminance at the maximum luminance level (e.g., 300 cd/m²). In this embodiment, when data is implemented with 256 gray scales, i.e., gray scales 0 to 255, the reference gray scale may be gray scale 255 or 171.

That is, in addition to data of the maximum gray scale (gray scale 255), data of another gray scale, e.g., data of gray scale 171, etc., at a gamma turning point marked on the luminance curve according to gray scales may be further applied to a display panel. In this case, screen analysis for a plurality of gamma turning points, i.e., a plurality of gray scales may be performed, and accordingly, the accuracy of luminance correction can be improved.

The luminance/color coordinate correction unit 152 may perform a luminance comparison operation of measuring chromaticity and luminance of the screen, determining a color coordinate based on the measured chromaticity, and obtaining a luminance difference between a predetermined target luminance and the measured luminance.

The luminance/color coordinate correction unit 152 sets a reference offset value for the reference luminance, corresponding to the analyzed result of the screen. More specifically, the luminance/color coordinate correction unit 152 may set a reference luminance offset value that allows luminance to be adjusted corresponding to the luminance difference of the target luminance with the reference scale obtained by the luminance comparison and a reference color coordinate offset value that allows chromaticity to be adjusted corresponding to the color coordinate for the reference gray scale.

For example, the luminance/color coordinate correction unit 152 may set, as a reference luminance offset value, a gamma adjustment value that enables the luminance difference between the target luminance and the measured luminance, and may set, as a reference color coordinate offset value, a color coordinate movement value with which a color coordinate distorted due to the luminance correction, problem on a process, etc. can be corrected.

In this case, the offset value corresponding to the luminance difference and/or the color coordinate may be derived from a predetermined numerical formula, graph, etc.

The luminance/color coordinate correction unit 152 may set a reference offset value so as to correct the gamma value for the reference gray scale. In addition, the luminance/color coordinate correction unit 152 may set an additional offset value(s) for at least one of the other gray scales except the reference gray scale and apply the set additional offset value to gamma voltage correction corresponding to the gray scale.

That is, the additional offset value is not a reference offset value for a reference gray scale, i.e., gray scale 255, 171, etc. but an additional offset value for the other gray scales except the reference gray scale. The additional offset value is set based on the reference offset value.

According to the luminance/color coordinate correction unit 152, a reference offset value for a reference gamma voltage corresponding to the reference gray scale is set, and the reference gamma voltage and the reference offset value are added up, thereby generating a corrected reference gamma voltage. Subsequently, if the additional offset value is set, the gamma voltage for gray scale 180 is corrected by adding up the reference offset value and the additional offset value.

Like the luminance correction, the color coordinate correction may be performed by reflecting a reference color coordinate offset value and an additional color coordinate offset value.

If the operation of the luminance/color coordinate correction unit 152 is performed as described above, a gamma table 152a and a gamma reference voltage LUT 152b are generated in the luminance/color coordinate correction unit 152. Here, the gamma table 152a is set to be optimized based on the condition in which the organic light emitting display device 100 emits light with the maximum luminance level. In the gamma reference voltage LUT 152b, voltage values of red, green and blue data corresponding to each gray scale and luminance at the maximum luminance level are recorded, based on the gamma table 152a.

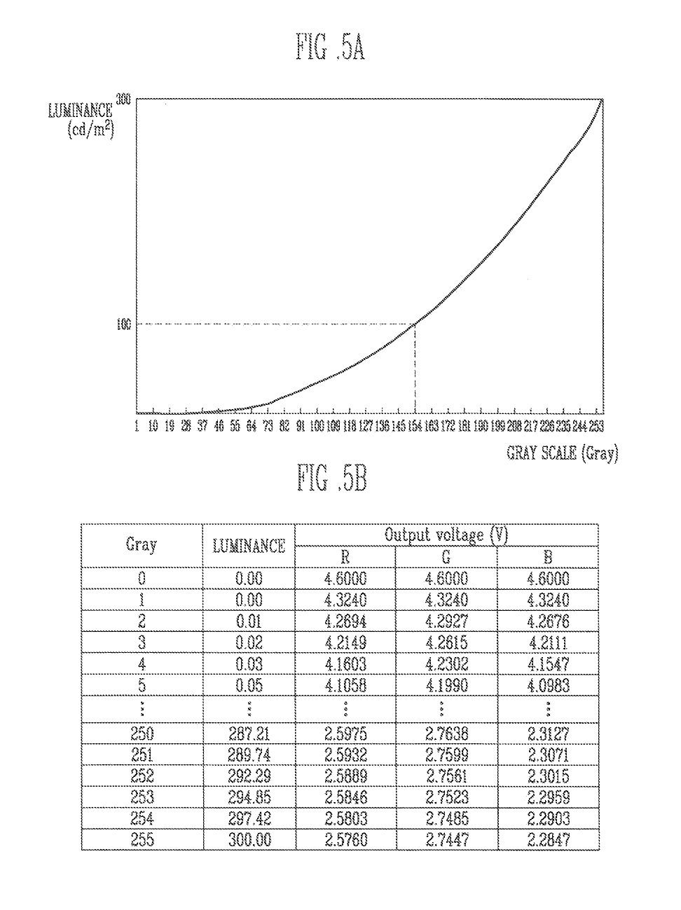

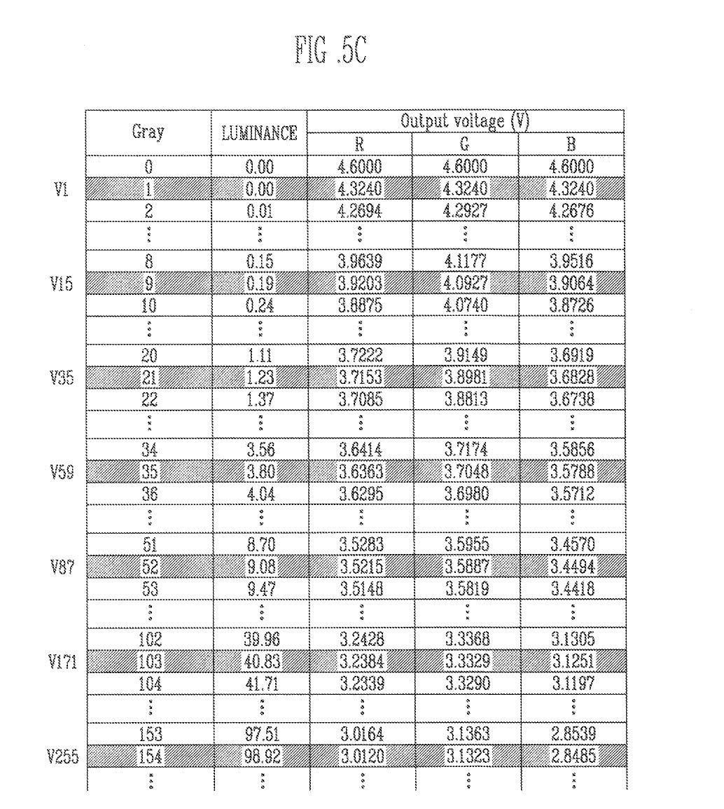

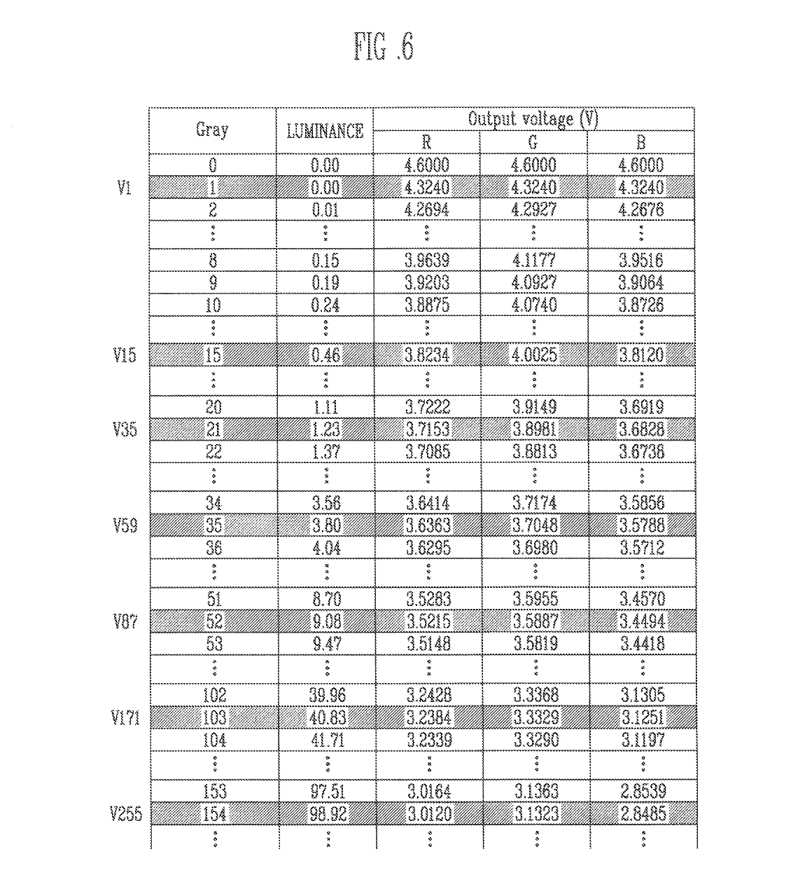

The optimized gamma table 152a may be implemented as the gamma curve shown in FIG. 5A, the gamma reference voltage LUT 152b may be implemented as the table shown in FIG. 5.

In this case, the gamma table 152a may be implemented as a separate gamma curve corresponding to red, green and blue data, but only the gamma curve for data of a specific color is shown in FIG. 5A. The gamma table 152a may be implemented in the form of an LUT in which luminance and gray scale values corresponding to the gamma curve are recorded.

That is, referring to the gamma curve optimized at the maximum luminance level (300 cd/m²), as shown in FIG. 5A, it can be seen that gray scales are in one-to-one proportion to luminance levels. Accordingly, the gray scale corresponding to a specific luminance can be obtained.

The gamma reference voltage LUT 152b shown in FIG. 5B is an LUT in which voltage values of red, green and blue data corresponding to each gray scale and luminance at the maximum luminance level are recorded, base on the gamma table shown in FIG. 5A. Referring to the gamma reference voltage LUT 152b, the voltage values of red, green and blue data corresponding to the specific luminance and gray scale can be obtained.

In this embodiment, data voltage V_{DATA} and driving current I_{OLED} applied to the pixel electrode of the organic light emitting diode are in an inverse proportion (T_{OLED}^{∝}−V_{DATA}) because of characteristics of the organic light emitting display device. Therefore, as shown in FIG. 5B, low luminance and low gray scale correspond to a high data voltage, and high luminance and high gray scale correspond to a low data voltage.

Accordingly, in dimming of the organic light emitting display device according to this embodiment, when assuming that a predetermined luminance level (dimming mode) is, for example, 100 cd/m², the gray scale corresponding to the dimming mode can be obtained with reference to FIG. 5A, and the voltages of red, green and blue data corresponding to the luminance and gray scale can be derived from FIG. 5B.

That is, the gray scale closest to the luminance level of a dimming mode to be implemented is set to a reference gray scale, and thus the data voltages of red, green and blue data corresponding to the reference gray scale can be determined as reference voltages.

FIG. 5C illustrates a portion of the LUT showing examples of voltage of red, green and blue data corresponding to the selected dimming mode (100 cd/m²). Referring to FIG. 5C, in a case where gray scale 154 as the approximate value of the gray scale corresponding to the luminance level of 100 cd/m² is selected as a reference gray scale, it can be seen that the voltage values of red, green and blue data corresponding to the gray scale 154 are 3.0120(V), 3.1323(V) and 2.8485(V), respectively.

That is, the data voltage can be obtained as the minimum gamma reference voltage (V255) corresponding to the selected dimming mode, and the voltage values corresponding to other intermediate gamma reference voltages (V1, V15, V35, V59, V87 and V171) can also be obtained as optimal voltage values through the LUT.

In this case, the obtained voltages of red, green and blue data is set to a gamma reference voltage corresponding to the dimming mode (100 cd/m²).

To this end, the gamma control signal output unit 154 outputs a gamma reference voltage control signal GCON corresponding to the corresponding dimming mode to the gamma correction circuit 400 with reference to the gamma table 152a and the gamma reference voltage LUT 152b, provided in the luminance/color coordinate correction unit 152.

That is, the gamma reference voltage control signal GCON is a signal for controlling the voltages of red, green and blue data corresponding to the selected dimming mode, obtained through the gamma reference voltage LUT 152b, to be set to reference voltages generated in the gamma correction circuit 400.

According to this embodiment, the luminance level (dimming mode) of the organic light emitting display device 100 can be controlled by adjusting the amplitudes of gray scale voltages V0 to V255 output from the gamma correction circuit 400.

To this end, the luminance/color coordinate correction unit 152 receive a target luminance level TRG representing the luminance level of the organic light emitting display device 100, and determines a gamma reference voltage control signal GCON to be provided to the gamma correction circuit 400 according to the target luminance level TRG, thereby controlling the luminance level of the organic light emitting display device 100. The gamma reference voltage control signal GCON may be determined with reference to each of the red, green and blue data.

The gamma correction circuit 400 sets a plurality of gamma reference voltages according to the gamma reference voltage signal GCON output from the gamma control signal output unit 154. The gamma correction circuit 400 generates gray scale voltages V0 to V255 corresponding to the corresponding luminance level through the gamma reference voltages and outputs the generated gray scale voltages.

In a case where the continuous dimming mode according to this embodiment is implemented, a gray scale (reference gray scale) closest to the luminance level of a dimming mode to be implemented is set in a low gray scale region as described above, and thus the data voltages of red, green and blue data corresponding to the reference gray scale is obtained as a reference voltage corresponding to the low gray scale region through the LUT.

More specifically, referring to FIG. 5C, gray scale 154 that is a gray scale closest to the gray scale corresponding to the luminance level of 100 cd/m² is selected as a reference gray scale through the LUT, and 3.0120(V), 3.1323(V) and 2.8485(V) that are voltage values of red, green and blue data corresponding to the reference gray scale are set to the minimum gamma reference voltage V255. The voltage values corresponding to other intermediate gamma reference voltages (V1, V15, V35, V59, V87 and V171) are also obtained as optimal reference voltage values through the LUT.

In case of V15 that is an intermediate gamma reference voltage corresponding to the low gray scale region, gray scale 9 is selected as a reference gray scale as shown in FIG. 5C, and 3.9203(V), 4.0927(V) and 3.9064(V) that are voltage values of red, green and blue data corresponding to the reference gray scale are set to the reference voltage (V15).

However, organic materials formed for each pixel so as to emit light of red, green and blue in the organic light emitting display device have a large distribution in a low gray scale region. Accordingly, in a case where the continuous dimming mode according to this embodiment is implemented, color distortion may occur in the low gray scale region.

That is, the reference gray scale used to set an intermediate gamma reference voltage in the low gray scale region may be changed depending on a selected dimming mode. If the reference gray scale in the low gray scale is changed for each dimming mode, the color coordinate (x, y) in the low gray scale region for each luminance corresponding to the selected dimming mode is changed due to the characteristics of the organic characteristics, and therefore, color distortion occurs.

Accordingly, in another embodiment of the present invention, a specific gray scale in a low gray scale region is fixed as a reference gray scale, a voltage of the set reference gray scale is actually measured, and the actually measured voltage is output as a gamma reference voltage in the low gray scale region, so that it is possible to overcome color distortion occurring in the low gray scale region when the continuous dimming mode is implemented.

That is, according to this embodiment, the gamma reference voltage in the low gray scale region is always set to a voltage corresponding to the fixed reference gray scale, regardless of the gamma reference voltage control signal GCON and the dimming mode described above.

For example, gray scale 15 is fixed as the reference gray scale in the low gray scale region, regardless of dimming modes, a voltage corresponding to the gray scale 15 is actually measured for each dimming mode, and the actually measured voltage is set to V15 that is a gamma reference voltage in the low gray scale region.

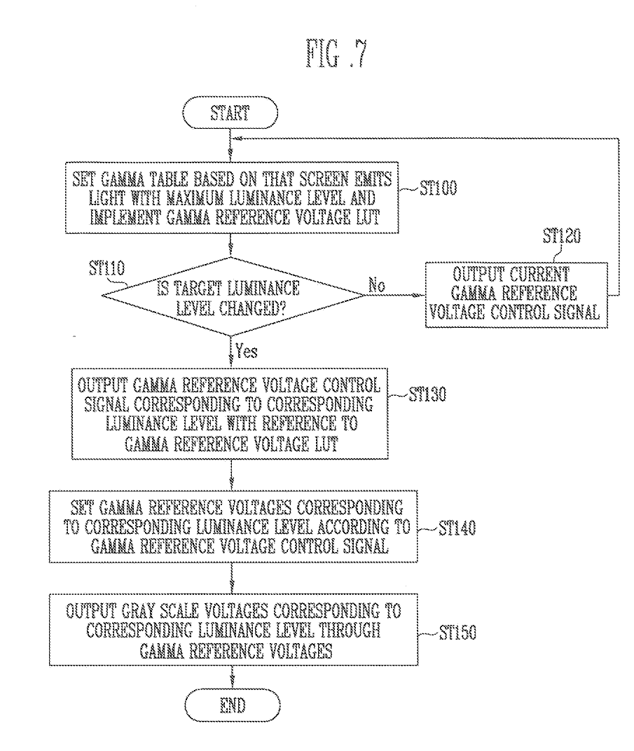

FIG. 6 is a view illustrating examples of a reference gray scale in a low gray scale region and voltage values of red, green and blue data corresponding to the reference gray scale when a specific dimming mode is selected according to another embodiment of the present invention.

For convenience of illustration, it is assumed that the selected specific dimming mode is set to 100 cd/m² so that this embodiment is compared with that of FIG. 5C.

Referring to FIG. 6, other gamma reference voltages (first gamma reference voltages) except V15 that is an intermediate gamma reference voltage representing the low gray scale region, i.e., the minimum gamma reference voltage (V255) and intermediate gamma reference voltages (V1, V35, V59, V87 and V171) are determined in the manner described with reference to FIGS. 5A to 5C.

In setting of the V15 that is a gamma reference voltage (second gamma reference voltage) corresponding to the low gray scale region, a specific gray scale (e.g., gray scale 15) is fixed as a reference gray scale for the low gray scale region, regardless of the selected dimming mode (100 cd/m²), a voltage corresponding to the gray scale 15 is actually measured in the selected dimming mode, and the actually measured voltage is set to V15, which is a gamma reference voltage in the low gray scale region.

Therefore, as shown in FIG. 6, the V15 that is the gamma reference voltage in the low gray scale region is set to 3.8234(V), 4.0025(V) and 3.8120V that are voltage values of red, green and blue data corresponding to the gray scale 15 as the fixed reference gray scale for the low gray scale region.

The fixing of the reference gray scale in the low gray scale region is identically applied to all dimming modes except the specific dimming mode (100 cd/m²) described in FIG. 6. Accordingly, the reference gray scale for the low gray scale region is fixed as the specific gray scale, e.g., the gray scale 15 in the dimming mode corresponding to 300 cd/m² that is the maximum luminance level and other selected dimming modes (e.g., 240 cd/m², 160 cd/m², etc.).

In the embodiment of FIG. 5 described above, the reference gray scale corresponding to the V15 that is the reference voltage in the low gray scale region becomes gray scale 9 in the selected dimming mode in which the luminance level is 100 cd/m².

In the dimming mode, the luminance corresponding to the gray scale 9 is 0.19 (cd/m²), and its color coordinate (x, y) is (0.2961, 0.2985).

On the other hand, in the dimming mode in which the maximum luminance level is 300 cd/m², the reference gray scale corresponding to the gray scale 15 is 0.48 (cd/m²), and its color coordinate (x, y) is (0.3053, 0.3109).

That is, the difference between color coordinates in the low gray scale region for each selected dimming mode is too large, which results in color distortion in the low gray scale region.

In the embodiment of FIG. 6, the reference gray scale corresponding to the V15 that is a gamma reference voltage for the low gray scale region is fixed as the gray scale 15, identically to that in other dimming modes, even in the selected dimming mode in which the luminance level is 100 cd/m².

In the selected dimming mode, the luminance corresponding to the gray scale 15 is 0.46 (cd/m²), and its color coordinate (x, y) is (0.3055, 0.3139).

It can be seen that the luminance (0.46 (cd/m²)) of the gray scale 15 corresponding to the V15 and its color coordinate (0.3055, 0.3139) in the selected dimming mode in which the maximum luminance is 100 cd/m² is hardly different from the luminance (0.48 (cd/m²)) of the gray scale 15 corresponding to the V15 and its color coordinate (0.3053, 0.3109) in the dimming mode in which the maximum luminance is 300 cd/m².

As a result, by applying the embodiment of FIG. 6, it is possible to overcome the color distortion occurring in the low gray scale region of the dimming mode. That is, in the implementation of the continuous dimming mode, a specific gray scale in the low gray scale region is fixed as a reference gray scale, a voltage of the fixed reference gray scale is actually measured in the dimming mode, and the actually measured voltage is output as a gamma reference voltage in the low gray scale region, thereby overcoming the color distortion.

FIG. 7 is a flowchart illustrating a method of generating a gray scale voltage according to an embodiment of the present invention.

Referring to FIGS. 6 and 7, the luminance/color coordinate correction unit 152 sets a reference offset value for performing gamma voltage correction for a predetermined reference gray scale (e.g., gray scale 255, gray scale 171, gray scale 87, gray scale 59, etc.), based on when the organic light emitting display device 100 emits light with the maximum luminance level, and sets an additional offset value(s) for at least one of the other gray scales except the reference gray scale. Thus, the luminance/color coordinate correction unit 152 sets an optimal gamma table 152a at the maximum luminance level by applying the additional offset value to the gamma voltage correction corresponding to the gray scale.

Further, voltage values respectively corresponding to gray scales 0 to 255 at the maximum luminance level are determined through the set optimal gamma table 152a. That is, the luminance/color coordinate correction unit 152 includes the gamma reference voltage LUT 152b in which voltage values of red, green and blue data corresponding to each gray scale and luminance at the maximum luminance level are recorded (ST100).

Subsequently, in a case where the target luminance is changed (ST110), e.g., if a user selects a dimming mode corresponding to a predetermined luminance level, the gamma control signal output unit 154 outputs a gamma reference voltage control signal GCON corresponding to the corresponding dimming mode to the gamma correction circuit 400 with reference to the gamma table 152a and the gamma reference voltage LUT 152b, provided in the luminance/color coordinate correction unit 152 (ST130).

In this case, the gamma reference voltage control signal GCON is a signal for controlling the gamma reference voltage obtained corresponding to the corresponding dimming mode as described above to be generated in the gamma correction circuit 400.

In a case where the target luminance is not changed (ST110), the gamma reference voltage control signal GCON currently output through the gamma control signal output unit 154 is continuously output to the gamma correction circuit 400 (ST120).

Next, the gamma correction circuit 400 sets gamma reference voltages except for a gamma reference voltage corresponding to a low gray scale region among the gamma reference voltages corresponding to the corresponding dimming mode (luminance level), according to the gamma reference voltage control signal GCON output from the gamma control signal output unit 154. Here, the gamma reference voltage corresponding to the low gray scale region is set by fixing a specific gray scale corresponding to the low gray scale region as a reference gray scale and actually measuring a voltage of the fixed reference gray scale in the corresponding dimming mode (ST140).

That is, the gamma reference voltage in the low gray scale region is always set to a voltage corresponding to the fixed reference gray scale, regardless of the gamma reference voltage control signal GCON and dimming modes.

For example, gray scale 15 may be fixed as the reference gray scale for the low gray scale region, regardless of dimming modes, a voltage corresponding to the gray scale 15 is actually measured for each dimming mode, and the actually measured voltage is set to V15 that is a gamma reference voltage corresponding to the low gray scale region.

In other words, in the setting of the V15 that is the gamma reference voltage corresponding to the low gray scale region, a specific gray scale (e.g., gray scale 15) is fixed as a reference gray scale for the low gray scale region, regardless of the selected dimming mode, a voltage corresponding to the gray scale 15 is actually measured in the selected dimming mode, and the actually measured voltage is set to V15 that is a gamma reference voltage corresponding to the low gray scale region.

Accordingly, a specific gray scale in a low gray scale region is fixed as a reference gray scale, a voltage of the set reference gray scale is actually measured, and the actually measured voltage is output as a gamma reference voltage in the low gray scale region, so that it is possible to overcome color distortion occurring in the low gray scale region when the continuous dimming mode according to this embodiment is implemented.

Next, if the plurality of gamma reference voltages are set, the gamma correction circuit 400 generates gray scale voltages V0 to V255 corresponding to the corresponding luminance level, i.e., the selected dimming mode, through the plurality of gamma reference voltages, and outputs the generated gray scale voltages V0 to V255 to the data driver 120.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method of generating a gray scale voltage in an organic light emitting display device, the method comprising:
setting a gamma table, based on the emission of light with a first luminance level by a screen displayed in a pixel unit of the light emitting display device, and implementing a gamma reference voltage lookup table (LUT) in which voltage values of red, green and blue data corresponding to each gray scale and luminances at the first luminance level are recorded based on the gamma table;
selecting a second luminance level different from the first luminance level;
outputting a gamma reference voltage control signal corresponding to the second luminance level with reference to the gamma table and the gamma reference voltage LUT;
receiving the gamma reference voltage control signal so as to set first gamma reference voltages corresponding to the second luminance level;
fixing a specific gray scale corresponding to a low gray scale region as a reference gray scale, actually measuring, at the second luminance level, a voltage corresponding to the fixed reference level, and setting the actually measured voltage as a second gamma reference voltage; and
generating gray scale voltages corresponding to the second luminance level through the plurality of set gamma reference voltages, and outputting the generated gray scale voltages to a data driver.

2. The method according to claim 1, the first gamma reference voltages being gamma reference voltages except the second gamma reference voltage corresponding to the low gray scale region.

3. The method according to claim 1, the second gamma reference voltage corresponding to the low gray scale region being set to a voltage corresponding to the reference gray scale, which is always fixed regardless of the gamma reference voltage control signal and the selected second luminance level.

4. The method according to claim 1, the reference gray scale being gray scale 15.

5. The method according to claim 1, the first luminance level being a maximum luminance level.

6. The method according to claim 1, the gray scale voltages being generated by dividing voltages between the plurality of gamma reference voltages.

7. The method according to claim 1, the gamma reference voltage control signal being a signal for controlling voltage values of the data obtained corresponding to the second luminance level through the gamma reference voltage LUT to be set to the first gamma reference voltages generated in a gamma correction circuit, the organic light emitting device expressing a plurality of gray scales.

8. The method according to claim 7, the gamma table being set by applying a reference offset value for performing gamma voltage correction for a predetermined reference gray scale, the method further comprising emission of light with the first luminance level based on said applied reference offset value and an additional offset value for performing gamma voltage correction for at least one of the other gray scales except the reference gray scale.

9. The method according to claim 8, the gamma table being set by applying a reference color coordinate offset value for a predetermined reference gray scale, the screen emitting light with the first luminance level based on said reference color coordinate offset value, and an additional color coordinate offset value for at least one of the other gray scales except the reference gray scale.

10. An organic light emitting display device, comprising:
a pixel unit having pixels coupled to a plurality of scan lines and a plurality of data lines;
a luminance/color coordinate correction unit that includes a gamma table set based on emission of light with a first luminance level from a screen displayed in a pixel unit of the light emitting display device, and a gamma reference voltage lookup table (LUT) in which voltage values of red, green and blue data corresponding to each gray scale and luminance at the first luminance level are recorded based on the gamma table;
a gamma control signal output unit that outputs a gamma reference voltage control signal corresponding to a second luminance level with reference to the gamma table and the gamma reference voltage LUT; and
a gamma correction circuit that receives the gamma reference voltage control signal so as to generate a plurality of gamma reference voltages corresponding to the second luminance level,
wherein a gamma reference voltage corresponding to a low gray scale region among the gamma reference voltages generated in the gamma correction circuit is generated by fixing a specific gray scale corresponding to the low gray scale region as a reference gray scale.

11. The organic light emitting display device according to claim 10, the gamma reference voltage corresponding to the low gray scale region being set to a voltage corresponding to the reference gray scale, which is always fixed regardless of the gamma reference voltage control signal and the selected second luminance level.

12. The organic light emitting display device according to claim 10, the reference gray scale being gray scale 15.

13. The organic light emitting display device according to claim 10, the first luminance level being a maximum luminance level.

14. The organic light emitting display device according to claim 13, the maximum luminance level being 300 cd/m².

15. The organic light emitting display device according to claim 10, the gamma correction circuit generating the gray scale voltages by dividing voltages between the plurality of gamma reference voltages.
